(19) United States
(12) Patent Application Publication
(10) Pub. No.: US 2008/0156180 A1
(43) Pub. Date: Jul. 3, 2008

(54) GUITAR AND ACCOMPANIMENT APPARATUS

(76) Inventor: Adrian Bagale, San Francisco, CA (US)

Correspondence Address: JOHN K. BUCHE, 7777 FAY AVENUE, SUITE 205, LA JOLLA, CA, 92037, US

(21) Appl. No.: 11/619,138

(22) Filed: Jan. 2, 2007

(51) Int. Cl. G10H 1/32

(52) U.S. Cl. 84/743

(57) ABSTRACT

An improved guitar and accompaniment apparatus featuring an electronic means configured to permit playback of a variety of accompaniment beats that may be selectively accessed and manipulated by the guitar player.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

The present application relates generally to the field of guitars, and, more particularly, to guitars featuring apparatus for providing accompaniment beats and rhythms useful for enjoyment of the instrument.

2. Background of the Invention

In the field of guitars, it often desirable to play the guitar with an accompanying beat or rhythm. The most obvious means of accomplishing accompaniment is simply by having another person play the desired beat, for instance, on a drum set. However, this arrangement is not always practicable or desirable, particularly since other musicians are not always available, and also because another musician is not always the best way to learn. For instance, a beginner guitar student may want to experiment with a variety of beats, tempos, or rhythms and not be subject to the limitations of another individual. Drum machines and synthesizers are capable of generating beats, however, they are not always desirable inasmuch as they typically require a device separate and apart from the guitar, which is inconvenient to a guitar player and often requires a comprehensive understanding of the drum machine, synthesizer, or computer mechanism responsible for generating such beats. Also, there is a need for an acoustic guitar player to be able to hear the beats being played, along with accompaniment in a substantially silenced mode, for instance, with the use of headphones.

There have been some attempts to merge guitars with recording or accompaniment mechanisms, however, all of the identified technologies suffer from significant drawbacks to the user of the instrument. For instance, U.S. Pat. No. 6,605,765 to Johnson (2003) features an acoustic guitar housing a cassette tape recorder, however, this technology requires first locating a suitable accompanying sound to record, then recording the sound, then playing the sound back with very limited playback capabilities. There is no ability to select from a variety of pre-recorded beats of different musical genres and adjust the tempos as desired. For this reason, and many others, the current application represents a significant improvement over available technologies.

U.S. Pat. No. 5,837,912 to Eagen (1998), discloses an electric guitar with a recording feature, but this technology is principally concerned with recording and playing back of the user's playing and does not teach the technology disclosed in this application. Similarly, U.S. Pat. No. 6,791,022 to Green (2004) teaches a practice and travel guitar, however, the device is not suitable for playing out loud and fails to teach the improvements of the present application.

### SUMMARY OF PREFERRED EMBODIMENTS

Accordingly, it is an objective of the present application and various embodiments described herein to provide an improved guitar with an embedded electronic apparatus operationally configured to permit playback of a variety of pre-recorded accompaniment beats.

It is another object of the present application and various embodiments described herein to provide pre-recorded beats in sound files, which include, but are not limited to, .MP3, AIFF, .AU, .WMA, .AAC, MID, KAR, MIDI, .WAV, and APE files, which sound files are stored on microchips and selectively activated by a user via a control unit means or buttons housed on the guitar.

It is yet another object of the present application and various embodiments described herein to provide an apparatus that provides accompaniment beats that vary considerably in genre, rhythm and style.

It is a further object of the present application to provide pre-recorded accompaniment beats that may be varied in tempo according to the user's preferences, or needs for “in time” training.

It is a further object of the present application to provide an ergonomically designed guitar with keypad control units within easy reach of the user and a speaker placement suited for private-practice or to an audience.

It is another preferable object of the present application and various embodiments described herein to provide an acoustic guitar that may be played with or without the accompaniment beats.

It is another object of the present application and various embodiments described herein to provide an guitar and accompaniment apparatus that may be played out loud through a speaker, or in a substantially quiet mode, where headphones are used to confine and superpose sounds from playing and the pre-recorded accompaniment beats.

It is another object of the present application and various embodiments described herein to provide an acoustic guitar and accompaniment apparatus that is beneficial and enjoyable to musicians of various ages and experience levels; that is cost-efficient to produce; and that is reasonably affordable to end users.

Other objectives of the application and various embodiments described herein will become apparent to those skilled in the art once the preferred embodiments have been shown and described. These objectives are not to be construed as limitations of applicant's invention, but are merely aimed to suggest some of the many benefits that may be realized by the apparatus and methods of the present application and with its many embodiments.

### BRIEF DESCRIPTION OF THE DRAWINGS

The manner in which these objectives and other desirable characteristics can be obtained is explained in the following description and attached drawings in which:

FIG. 1 is a perspective view of one preferable embodiment of the guitar featuring various components, including a control panel unit with buttons, speaker unit, headphone jack, battery housing, and microphone, among others.

FIG. 2 is an exploded perspective view of one preferable embodiment of the guitar showing exploded views of a speaker unit and a control panel unit.

FIG. 3 is an overhead view of the side surface of one preferred embodiment of the guitar, showing one preferable arrangement of buttons, control panel, battery unit, and speaker.

FIGS. 4A, 4B, 4C and 4D are to be viewed together and are circuit board schematics for one possible electronic configuration for a preferred embodiment of this application.

FIG. 5 is a list of preferable parts for use with the embodiment disclosed in FIGS. 4A-4D.

It is to be noted, however, that the appended drawings illustrate only typical embodiments of this invention and are therefore not to be considered limiting of its scope, for the invention may admit to other equally effective embodiments that will be appreciated by those reasonably skilled in the relevant arts. Also, drawings are not necessarily made to scale but are representative.

### DETAILED DESCRIPTION OF PREFFERED EMBODIMENTS

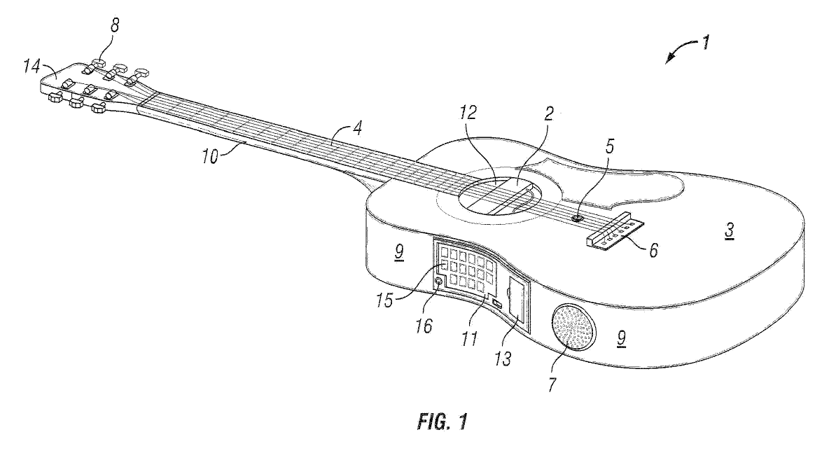

FIG. 1 is a perspective view of one preferable embodiment of the guitar 1 featuring various basic components, including a control panel unit 11 with buttons 15, speaker unit 7, headphone jack 16, battery housing 13, and microphone 5. Principal benefits of embodiments of the present application are that they permit a guitar player to selectively and conveniently access pre-recorded beats to accompany his or her playing.

As is shown in FIG. 1, a preferable arrangement for the guitar 1 provides a control unit 11 housed within the side surface 9 of the guitar 1 so that it faces upward relative to the player. With this arrangement, the buttons 15 are ideally suited for ease of access to the player of the instrument. A variety of buttons 15 may be found on the guitar 1, with separate buttons 15 correlating to and being operationally configured to activate accompaniment beats of varying genres of music. For instance, there may be buttons 15 for activating salsa beats, polka beats, rock n' roll beats, waltzes, country beats, Tejano beats, jazz beats, world, swing beats, hip-hop beats, reggae or island beats, gospel, folk beats, and others that will be appreciated by those in the music industry. Also, applicant contemplates that suitable buttons 15 may correlate to beats selectively downloaded by the user for use in conjunction with the guitar 1. Other buttons 15 may be used to control tempo of the chosen beats. For example, button(s) can move a beat tempo to “slow”, “medium” or “fast” or alternately between 60/80/120 beats per minute, although any range of beats per minute might also be provided. The term “button” for purposes of this application is also intended to cover any device or mechanism suitable by a user for activating a particular electronic beat, such term including, but not limited to toggles, switches, knobs, dials, levers, slides, and the like. Separate buttons 15 can be used to turn the control unit 11 and accompaniment mechanism “on/off” to save battery life, or when the user wishes to play the guitar without accompaniment. Also, “button” may include a control for volume of the accompaniment beats and sound delivered to either the speaker or headphones. For ease of access, the guitar 1 features a battery housing 13 at a preferred location on the side surface 9 of guitar 1, although a variety of battery locations may also be suitable.

FIG. 1 also depicts a preferable position of a speaker unit 7, housed within side surface 9 of guitar 1, and facing upward on the top of guitar 1 toward a player of the instrument. The guitar 1 will have at least one speaker unit 7. Although other arrangements may be preferable, sound from the speaker unit 7 is directed largely toward the player, which is particularly beneficial when the user is not entertaining or merely wants to operate in a practice mode. Pre-recorded accompaniment beats emanate from speaker 7, unless bypassed by use of headphones inserted into a headphone jack 16, also depicted in FIG. 1. In instances where a headphone is engaged with the guitar 1, sound from strumming of the strings 4 is preferably picked up by use of an optional pickup 2 or by use of a microphone 5, which is securely mounted beneath the strings of the instrument. In FIG. 1, microphone 5 is mounted to the face 3 of the guitar 1 at a point beneath the strings, and between the sound hole 12 and bridge 6. Microphone 5 is preferably omni-directional. When headphones are engaged, the user hears the blended sound of strumming and pre-recorded accompaniment. Also, it is possible to filter the blended guitar strumming and accompanied beats through to an amplifier. Also shown in FIG. 1 are components basic to any acoustic guitar, namely, a neck 10, strings 4, peg head 14, tuning keys 8, sound hole 12, and optional pickup 2.

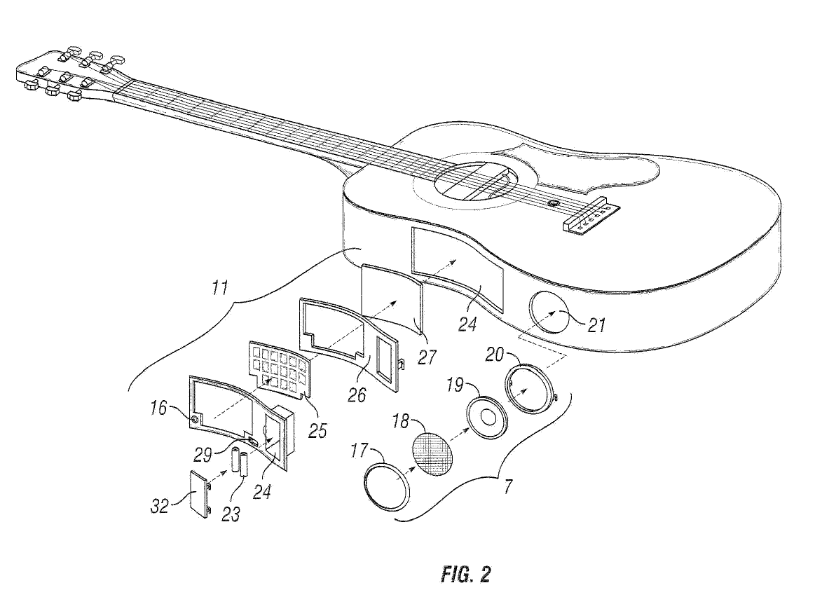

FIG. 2 is a perspective view of the embodiment of FIG. 1, but with views of preferred control panel unit 11 and speaker unit 7. A variety of physical configurations might be devised for control panel unit 11, with one primary role for the unit 1 being to provide a convenient interface to the player of the guitar 1 to select, activate and manipulate the pre-recorded beats stored on microchips housed inside the guitar 1. The control panel unit 1 provides electronic or computer means for processing user instructions and choices of accompaniment beats and delivering the selected beats to either a speaker 19, or alternately to headphones, or to an amplifier, where the selected beats are converted to audible sound. The selected beats are accessed from and typically stored in the form of sound files found on the main PCB 27. These sound files may include, but are not limited to, .MP3, AIFF, .AU, .WMA, .AAC, MID, .KAR, MIDI, .WAV, and APE files. The control panel unit 11 is also preferably configured and features electronic means, or computer means, to process incoming signals from either optional pickups(s) 2 or microphone 5, which signals may be blended electronically with accompaniment beats and filtered to headphones, amplifiers, or speaker 19. It is not a requirement that speaker 19 blend sounds from strumming and the accompaniment beats, but it is an option. The user may prefer that only accompaniment beats emanate from the speaker 19, while strumming sounds are projected in a conventional manner from the acoustic guitar.

In FIG. 2, control panel unit 11 is shown comprising exterior housing 24, keypad membrane 25, back plate 26, main PCB 27, and control unit orifice 28. In a preferred embodiment of control panel unit 11 shown in FIG. 2, exterior housing 24 and back plate 26 are configured to hold in place and operationally connect keypad membrane 25 to a main PCB (printed circuit board) and to secure the entire unit by securing means into a control unit orifice 28 in the body of guitar 1. The securing means for placing control panel unit 11 within control unit orifice 28 can vary considerably, but may be suitably in the form of a snug fit, adhesives, or snapping fit, to name a few. Exterior housing 24 is shown with an integrally situated battery receiving case, batteries 23 for operating the electronic components of the guitar 1, a battery door 22 adapted for preferable hinging connection to the exterior housing 24, and a head phone jack 16, which head phone jack 16 provides a physical and electrical coupling for the plug and power cord to headphones. A back plate 26 is depicted in FIG. 2 with a shape complimentary to and for coupling to exterior housing 24, and back plate 26 being further configured to secure keypad membrane 25. Keypad membrane 25 features a plurality of buttons, which buttons 15 may correlate, as previously described, to specific accompaniment beats, tempos, volume, guitar performance modes, or sound effects desired by the user. The keypad 25 is typically designed as a thin membrane of approximately 1 millimeter in thickness and having contact material such as silver paste painted on a Mylar® polyester film. The keypad 25 is mounted so that it may have contact with main PCB 27. Optionally, the keypad membrane 25 and main PCB 27 may be fixedly secured to one another by a mounting plate means with a thin rubber or synthetic polymer with elastomeric properties to facilitate more reliable contact. The main PCB 27 is designed to hold the electronic circuits and microprocessor chips/semiconductors employed by guitar 1. A Sunplus brand microprocessor chip is one that has been identified as particularly well suited for use with an embodiment of the present application and for storage and playback of sound files. Suitable sound files include, but are not limited to, .MP3, AIFF, .AU, .WMA, .AAC, MID, .KAR, MIDI, .WAV, and APE files. One particularly ideal main PCB 27 is a tissue PCB of approximate dimensions of 63×35×1.6 millimeters. The main PCB 27 is configured to be electrically coupled to a power source, preferably a battery power source, and typically uses a mini UL plug connector to accomplish the coupling. Separate mini electrical connectors may be used to connect speaker unit 7 or speaker 19 and microphone 5 to a power source, which is also preferably battery, although other power sources are contemplated.

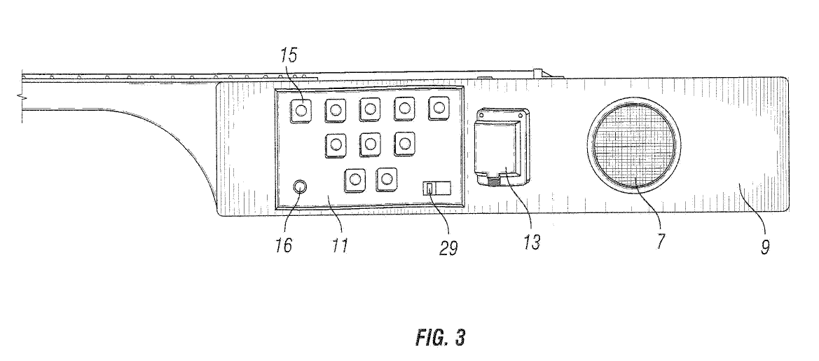

FIG. 3 is an overhead view of yet another preferable embodiment and example of the guitar 1 of the present application. This view demonstrates how a control panel unit 11, battery housing 13, and speaker unit 7 (speaker 19) are all optionally situated on a side surface 9 on the top of guitar 1. This arrangement is particularly convenient and ergonomically positioned for ease of use by a guitar player. Buttons 15 on keypad 25 are all suitably in easy reach of the player's fingertips; the speaker unit 7 is in close earshot (allowing for audible beats in close range); and the batteries 23 may be easily changed because of the location. Also shown in FIG. 3 are headphone jack 16, which can be used with headphones where a player wants electronic signals that would otherwise be sent to the speaker unit 7 to be transmitted to headphones for silent playing. An on/off switch 29 is also featured on the keypad membrane 25 of the control panel unit 11, although the placement of this switch 29 might easily vary, with a central purpose being simply to turn the electronic features of guitar 1 on or off. It should be noted that guitar 1 may be an acoustic guitar, so that it may be played independently of any particular accompaniment, or alternately where playing is not amplified, but only the accompaniment beats.

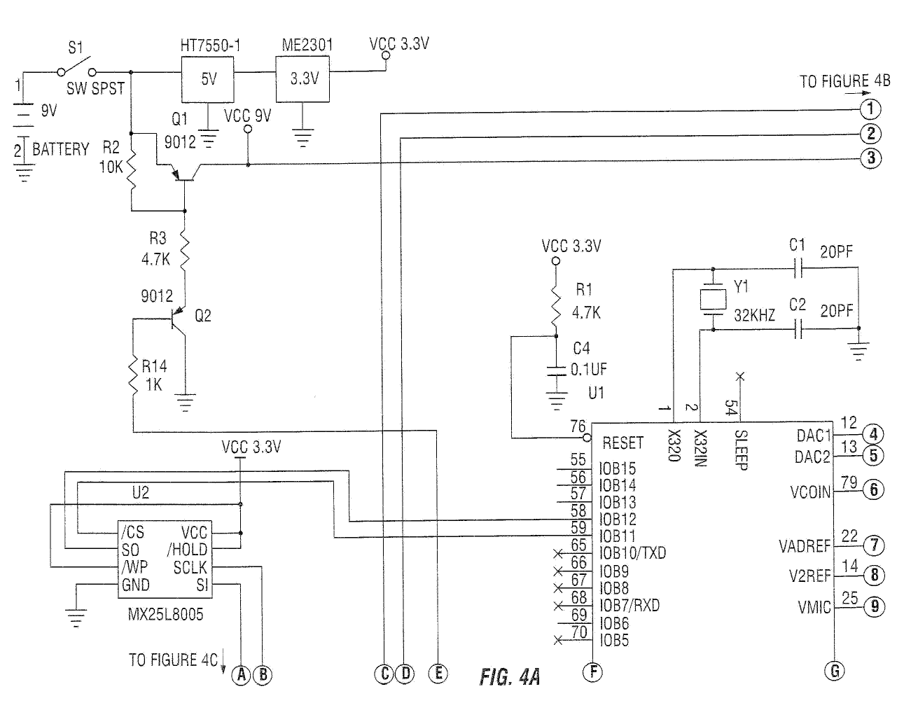

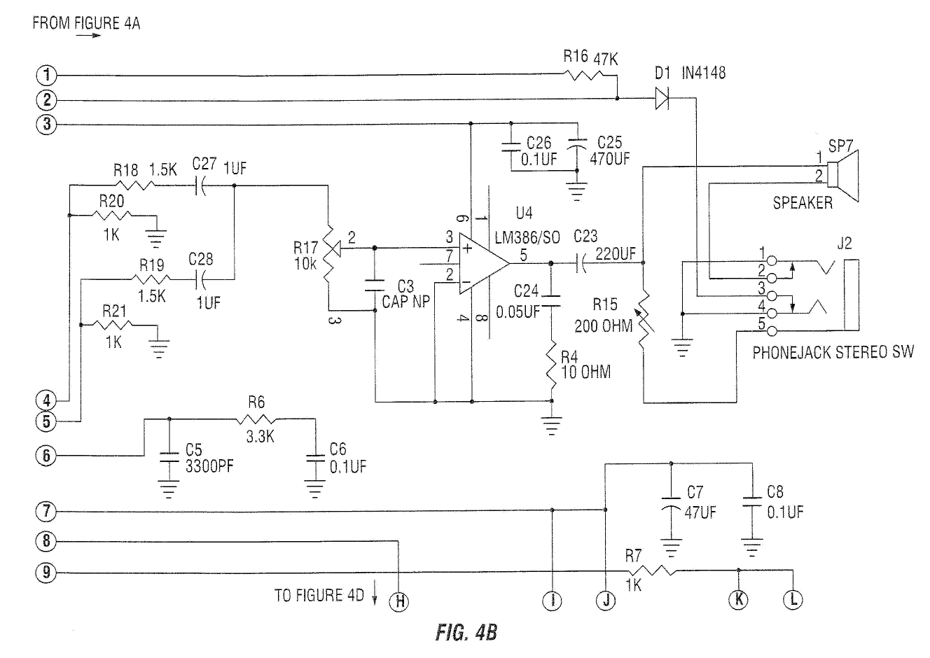

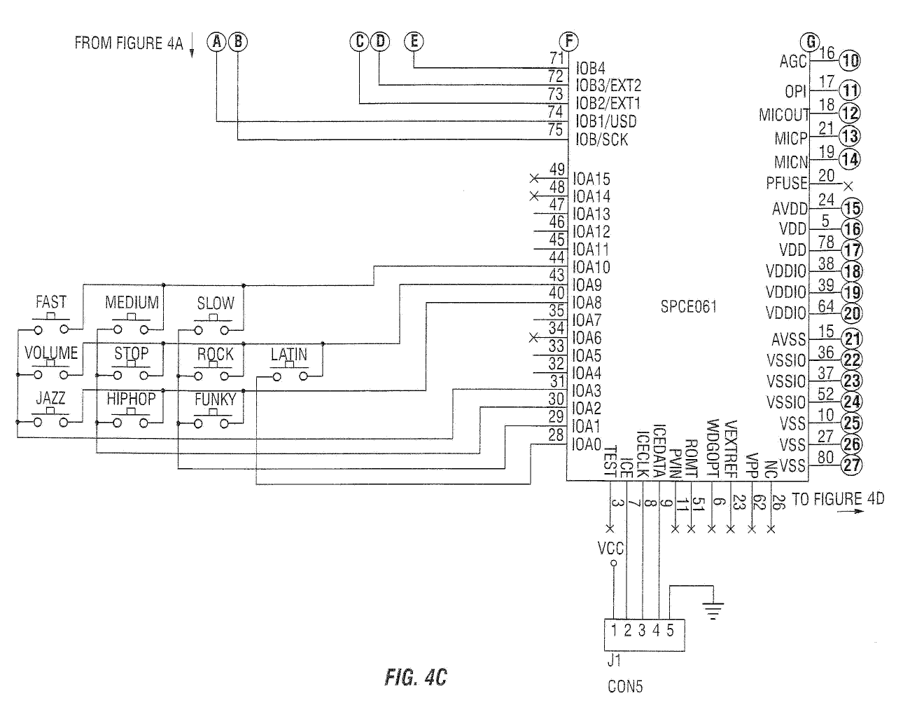

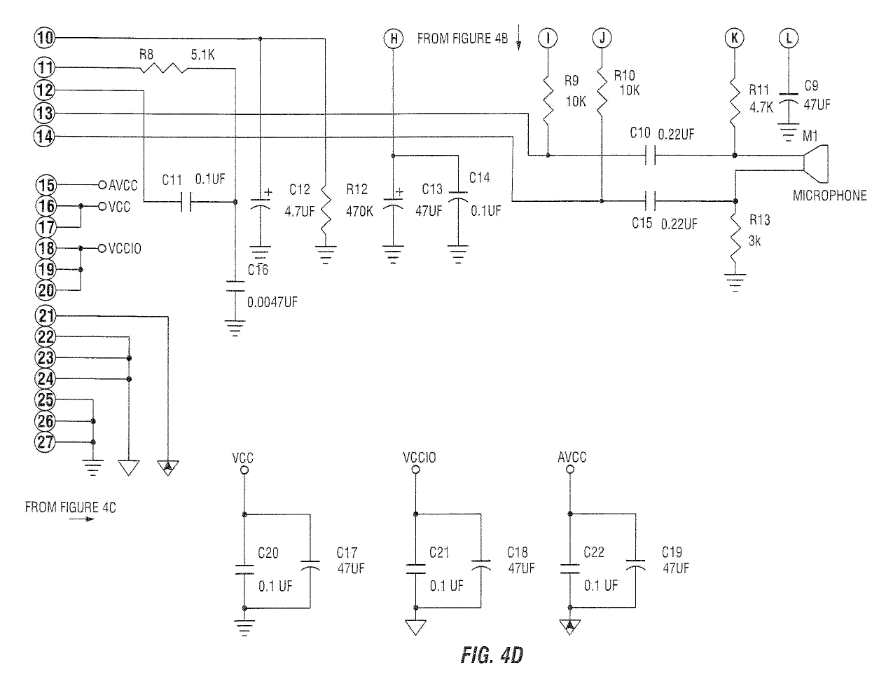

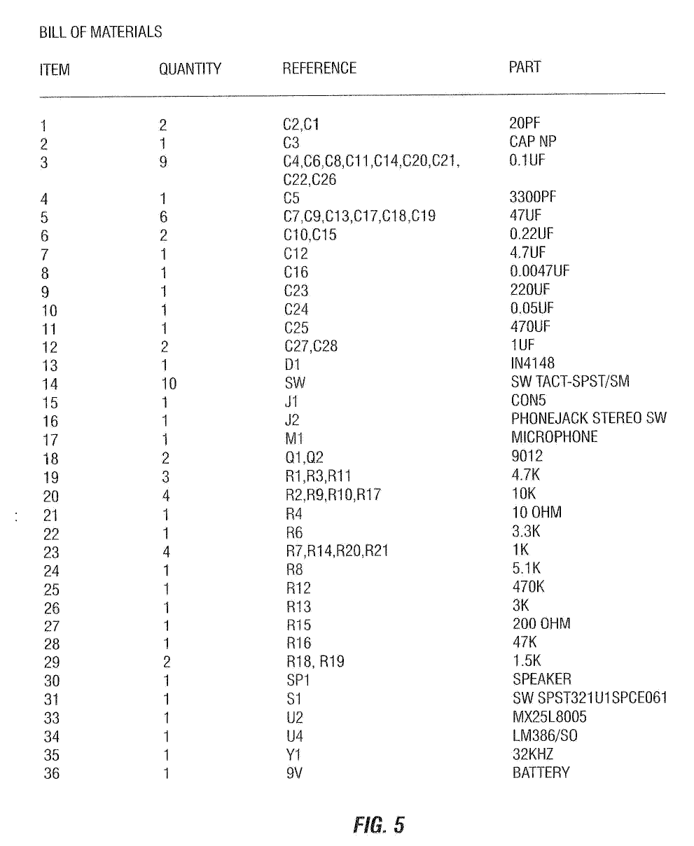

FIGS. 4A-4D are to be viewed together and are circuit board schematics for one possible electronic configuration for one embodiment of the guitar 1 of the present application. FIG. 5 is a related list of some of the electronic parts and descriptions for use with the embodiment disclosed in the example of FIGS. 4A-4D, which description will be appreciated by those skilled in the arts. These combined schematics explain how sound may be generated by and through use of the various electric switches that couple buttons to the stored sound files, and how these same files may be accessed. The bill of materials in FIG. 5 is not intended to be limiting of the components that may potentially be used to accomplish the ends of the embodiments of the present application, but is instead offered as an example of one suitable mode of operation for an embodiment featuring five styles for musical beats (rock, hip hop, jazz, Latin, funky) which may be played in three separate tempos (slow, medium, fast), and also featuring a small omni-directional microphone, speaker output, battery power source and an optional headphone jack.

Referring now still to FIGS. 4A-D and FIG. 5 and considering power supply, an embodiment is disclosed, by way of a nonlimiting example, wherein a power switch for on/off is coded as S1, which is accomplished by a preferable toggle, and where a red LED is designed to illuminate for five seconds, unless a function button/switch (S5-12) is depressed. Where a CPU (U3)(SPCE061) is preferably working in 3.3V, a regular IC (HT7533) (U1) may be used to convert a 9V battery to 3.3V to provide a stable power source to CPU (U3) and a flash memory IC (U4). For providing enough sound power to drive a 1-Watt (4 ohm) speaker, a main audio power IC (U2)(LM386) may still operate in 9V mode by switching Q1(8550) and Q2 (9014C) (FIG. 4A). Where the U2 (LM386) is not a low power consumption IC, power may be controlled by U2 (SPCE061) through a pin IOB4 to achieve power saving after no sound has been played for some seconds. Other ICs can be designed as low power ICs that only work at microamperes in standby mode.

Referring now still to FIGS. 4A-D and FIG. 5 and considering circuit operation, an embodiment is disclosed, by way of a nonlimiting example with nonlimiting optional parts, wherein main control IC (U2)(SPCE061) operates in 32.768 KHz clock rate and with flash memory capable of being updated via an external programming device through a connector J3. Flash memory IC (U4)(MX25L8005) is used to store the sound files, including but not limited to, .MP3, AIFF, .AU, .WMA, .AAC, MID, KAR, MIDI, .WAV, and APE files. A general flow of the displayed program is that main control IC (U2) scans output from IOA8-10 and where buttons/switches (S5-S12) are depressed and detected by pin IOA0-3, so that main control will then execute the action to match the appropriate program. For example, the S5 button can act as the tempo control for sound effects referred to by buttons S8-S12 (Rock, World, Jazz, Hip Hop, Funky), and where S5 is also toggled for three tempos (slow, medium, fast cycling). Button S6 is toggled with a volume control of low, mid and high. Button S7 can act to stop the playing of all accompaniment beats immediately, for instance, where the musician wants to perform an unaccompanied guitar solo. Additionally, main control IC (U2) may be configured to capture input from microphone 5, which detects sounds created from playing the guitar 1. Where headphones are connected to guitar 1, this action can be detected, for instance via IOB2 and IOB3, causing the speaker unit 7 sound to stop immediately and where the sound(s) of accompaniment beats and strumming may be heard together via the headphones in a substantially subdued or quieter playing mode. This superposed sound can also be conveyed to an external amplifier where the merged playing and accompaniment beats may be broadcast.

Disclosed in this paragraph, as nonlimiting optional embodiments, are the following: a guitar and accompaniment apparatus comprising: a guitar 1 with a face 3, side surface 9, sound hole 12, neck 10, strings 4; bridge 6, peg head 14, and tuning keys 8; an electronic means housed in said guitar 1, said electronic means operationally configured to retrieve and play sound files; a plurality of buttons 15 affixed upon said guitar 1 for engaging said electronic means and selectively operating said sound files; said sound files playable through at least one speaker 19 housed in said guitar 1; and, a power source for operating said electronic means. Also disclosed are a guitar and accompaniment, wherein sound files are stored on a main PCB (printed circuit board) 27. Also disclosed is a guitar and accompaniment apparatus wherein buttons 15 are on a keypad membrane 25 electrically coupled to a main PCB 27. A guitar and accompaniment apparatus are further disclosed wherein said power source is a battery 23. A guitar and accompaniment apparatus is disclosed wherein said power source is a battery(ies) 23 housed in said guitar so that the guitar is configured to function and play accompaniment beats without the need for a power cord, although a power cord might also be used to supply power. A guitar and accompaniment apparatus is disclosed further comprising a microphone 5 affixed in a face 3 of said guitar 1 at a location beneath the strings 4 at a point between said neck 10 and said bridge 6. A guitar and accompaniment apparatus are disclosed further comprising a headphone jack 16. A guitar and accompaniment apparatus a further disclosed comprising electronic means for superposing accompaniment beats and input from said microphone (5 or 2) and delivering said superposed data to a speaker 19 where it is broadcast. A guitar and accompaniment apparatus are disclosed wherein said speaker is a set of headphones that permits the user to hear both accompaniment beats and his or her superposed playing though said headphones. A guitar and accompaniment apparatus are disclosed with electronic means for bypassing sounds to a speaker 19 when headphones are plugged into said guitar 1. A guitar and accompaniment apparatus is disclosed wherein at least one of said buttons 15 is located along the side surface 9 of said guitar. A guitar and accompaniment apparatus is disclosed wherein at least one speaker 19 is mounted in said guitar 1 along the side surface 9 of said guitar 1. A guitar and accompaniment apparatus with at least one button 15 for adjusting tempo of selected accompaniment beats. A guitar and accompaniment apparatus with a plurality of buttons 15 that correlate to accompaniment beats of specific musical styles, said buttons being from any of the group of musical styles consisting essentially of either of salsa, rock, jazz, world, funky, swing, hip-hop, or reggae. A guitar and accompaniment apparatus is disclosed having a means for controlling volume of said speaker 19. A guitar and accompaniment apparatus are disclosed further comprising a control panel unit 11, said control panel unit 11 removably securable within a control unit orifice 28. A guitar and accompaniment apparatus are disclosed wherein said control panel unit mechanically and electrically couples a keypad membrane 25 and a main PCB 27 that houses memory for storing sound files and the electric circuits useful for actuating and audibly playing said sound files through a speaker. A guitar and accompaniment apparatus are disclosed wherein said speaker 19 is housed in a speaker unit 7 that is securable within a speaker receiving orifice 21 in said guitar. A guitar and accompaniment apparatus are disclosed comprising: a control panel unit 11 housed in said guitar 1, said control panel unit defining a plurality of buttons 15 upon a keypad; said buttons 15 useable for activating electronic means to access sound files contained on microprocessor chips located in said guitar 1. A guitar and accompaniment apparatus are further disclosed comprising a main PCB (printed circuit board) 27 that contains circuits for storing, accessing, and audibly playing said sound files. A method is disclosed of playing a guitar with an accompaniment feature comprising: turning on a power source to an electronic accompaniment means housed in said guitar 1; pressing buttons 15 on a keypad of said guitar where said buttons 15 correlate to specific accompaniment beats; activating electronic means by depressing said buttons 15 to engage and play said accompaniment beats stored in sound files; using electronic means to play said accompaniment beats through at least one speaker 19; playing the guitar with the accompaniment beats. A method is disclosed with a further step of pressing at least one button 15 configured to adjust the tempo of said accompaniment beats. A method is also disclosed with further steps of: using a microphone (2,5) to pickup playing of the guitar and convert vibrations from the playing to electronic data; using electronic means to superpose accompaniment beats with said electronic data from playing; and, delivering superposed accompaniment beats and electronic data from playing to at least one speaker. Another method is disclosed, further including the step of activating a set of headphones to electronically bypass sound delivery of accompaniment beats that would otherwise go to a speaker. Disclosed are a guitar and accompaniment apparatus comprising: a guitar and an electronic means housed in said guitar, said electronic means operationally configured to retrieve and play sound files featuring pre-recorded accompaniment beats; a plurality of buttons 15 affixed upon said guitar 1 for selectively engaging said electronic means and choosing particular sound files to play; said sound files being playable through at least one speaker 19 housed in said guitar 1; and, a power source for operating said electronic means. A guitar is further disclosed wherein said sound files are .WAV or .MP3 files. A guitar is further disclosed wherein at least one of said buttons 15 allows for adjustment of accompaniment beat tempo. A guitar of claim is further disclosed wherein at least one of said buttons allows a user to adjust volume of said accompaniment beats. A guitar is disclosed further comprising a main PCB (printed circuit board) 27 that contains circuits for storing, accessing, and audibly playing said sound files.

I claim:

1. A guitar and accompaniment apparatus comprising:
a guitar with a face, side surface, sound hole, neck, strings; bridge, peg head, and tuning keys;
an electronic means housed in said guitar, said electronic means operationally configured to retrieve and play sound files;
a plurality of buttons affixed upon said guitar for engaging said electronic means and selectively operating said sound files;
said sound files playable through at least one speaker housed in said guitar; and,
a power source for operating said electronic means.

2. The guitar and accompaniment apparatus of claim 1, wherein said sound files are stored on a main PCB (printed circuit board).

3. The guitar and accompaniment apparatus of claim 2 wherein buttons are on a keypad membrane electrically coupled to said main PCB.

4. The guitar and accompaniment apparatus of claim 1, wherein said power source is a battery.

5. The guitar and accompaniment apparatus of claim 1 wherein said power source is a battery housed in said guitar so that the guitar is configured to function and play accompaniment beats without the need for a power cord.

6. The guitar and accompaniment apparatus of claim 1, further comprising a microphone affixed in a face of said guitar at a location beneath the strings at a point between said neck and said bridge.

7. The guitar and accompaniment apparatus of claim 1, further comprising a headphone jack.

8. The guitar and accompaniment apparatus of claim 1, further comprising electronic means for superposing accompaniment beats and input from said microphone and delivering said superposed data to a speaker where it is broadcast.

9. The guitar and accompaniment apparatus of claim 1, wherein said speaker is a set of headphones that permits the user to hear both accompaniment beats and his or her superposed playing though said headphones.

10. The guitar and accompaniment apparatus of claim 1, with electronic means for bypassing sounds to a speaker when headphones are plugged into said guitar.

11. The guitar and accompaniment apparatus of claim 1, wherein at least one of said buttons are located along the side surface of said guitar.

12. The guitar and accompaniment apparatus of claim 1, wherein at least one speaker is mounted in said guitar along the side surface of said guitar.

13. The guitar and accompaniment apparatus of claim 1, with at least one button for adjusting tempo of selected accompaniment beats.

14. The guitar and accompaniment apparatus of claim 1, with a plurality of buttons that correlate to accompaniment beats of specific musical styles, said buttons being from any of the group of musical styles consisting essentially of either of salsa, rock, jazz, world, funky, swing, hip-hop, or reggae.

15. The guitar and accompaniment apparatus of claim 1, having a means for controlling volume of said speaker.

16. The guitar and accompaniment apparatus of claim 1, further comprising a control panel unit, said control panel unit removably securable within a control unit orifice.

17. The guitar and accompaniment apparatus of claim 16, wherein said control panel unit mechanically and electrically couples a keypad membrane and a main PCB that houses memory for storing sound files and the electric circuits useful for actuating and audibly playing said sound files through a speaker.

18. The guitar and accompaniment apparatus of claim 1, wherein said speaker is housed in a speaker unit that is securable within a speaker receiving orifice in said guitar.

19. A guitar and accompaniment apparatus comprising:
A control panel unit housed in said guitar, said control panel unit defining a plurality of buttons upon a keypad;
Said buttons useable for activating electronic means to access sound files contained on microprocessor chips located in said guitar.

20. The guitar and accompaniment apparatus comprising of claim 19, further comprising a main PCB (printed circuit board) that contain circuits for storing, accessing, and audibly playing said sound files.

21. A method of playing a guitar with an accompaniment feature comprising:
Turning on a power source to an electronic accompaniment means housed in said guitar;
Pressing buttons on a keypad of said guitar where said buttons correlate to specific accompaniment beats;
Activating electronic means by depressing said buttons to engage and play said accompaniment beats stored in sound files;
Using electronic means to play said accompaniment beats through at least one speaker;
Playing the guitar with the accompaniment beats.

22. The method of claim 21, wherein said accompaniment beats are of various musical genres consisting essentially of any of the group of musical styles being any of salsa, polka, rock n' roll, waltzes, country, jazz, world, funky, swing, hip-hop, reggae, gospel, folk, island, country or Tejano.

23. The method of claim 21 with a further step of pressing at least one button configured to adjust the tempo of said accompaniment beats.

24. The method of claim 21 with further steps of:
using a microphone to pickup playing of the guitar and convert vibrations from the playing to electronic data;
using electronic means to superpose accompaniment beats with said electronic data from playing; and,
delivering superposed accompaniment beats and electronic data from playing to at least one speaker.

25. The method of claim 21 further including the step of activating a set of headphones to electronically bypass sound delivery of accompaniment beats that would otherwise go to a speaker.

26. A guitar and accompaniment apparatus comprising:
a guitar and an electronic means housed in said guitar, said electronic means operationally configured to retrieve and play sound files featuring pre-recorded accompaniment beats;
a plurality of buttons affixed upon said guitar for selectively engaging said electronic means and choosing particular sound files to play;
said sound files playable through at least one speaker housed in said guitar; and,
a power source for operating said electronic means.

27. The guitar of claim 26 wherein said sound files are .WAV or .MP3 files.

28. The guitar of claim 26 wherein at least one of said buttons allows for adjustment of accompaniment beat tempo.

29. The guitar of claim 26 wherein at least one of said buttons allows a user to adjust volume of said accompaniment beats.

30. The guitar of claim 26, further comprising a main PCB (printed circuit board) that contains circuits for storing, accessing, and audibly playing said sound files.
